(19) United States
(12) Patent Application Publication
(10) Pub. No.: US 2008/0239129 A1
(43) Pub. Date: Oct. 2, 2008

(54) METHOD AND DEVICE FOR DRIVING SOLID-STATE IMAGING DEVICE, IMAGING APPARATUS, AND IMAGE SYNTHESIZING METHOD

(76) Inventors: Hiroyuki OSHIMA, Kurokawa-gun (JP); Hirokazu Kobayashi, Saitama-shi (JP)

Correspondence Address: BIRCH STEWART KOLASCH & BIRCH, PO BOX 747, FALLS CHURCH, VA, 22040-0747, US

(21) Appl. No.: 12/057,233

(22) Filed: Mar. 27, 2008

(30) Foreign Application Priority Data
Mar. 30, 2007 (JP) P2007-094675

(51) Int. Cl. H04N 5/335

(52) U.S. Cl. 348/311; 348/E05.091

(57) ABSTRACT

A method for driving a solid-state imaging device including a plurality of pixels arranged in a two-dimensional array, each of the plurality of pixels accumulating a signal charge according to an amount of incident light, is provided. The method includes: performing electron multiplication of a first signal charge at a first multiplication factor to output a first image signal; and performing electron multiplication of a second signal charge at a second multiplication factor to output a second image signal, at least the first and second image signals being image signals of the same scene of a subject and being successively output.

This application is based on and claims priority under 35 U.S.C. §119 from Japanese Patent Application No. 2007-94675 filed Mar. 30, 2007, the entire disclosure of which is herein incorporated by reference.

### BACKGROUND OF THE INVENTION

1. Field of the Invention

This invention relates to a method and device for driving a solid-state imaging device, an imaging apparatus, and an image synthesizing method in the imaging apparatus, which are capable of taking an image in a wide dynamic range.

2. Description of Related Art

JP-A-6-141229 discloses an example of a camera for taking an image in a wide dynamic range. In JP-A-6-141229, an overexposure image and an underexposure image of the same subject are continuously taken and are synthesized to widen the dynamic range of the image.

In JP-A-59-210775, a solid-state imaging device is provided with both low-sensitivity pixels and high-sensitivity pixels, and low-sensitivity image data taken with the low-sensitivity pixels and high-sensitivity image data taken with the high-sensitivity pixels are synthesized to widen the dynamic range of the image.

In a recent solid-state imaging device, making finer pixels advances and both the sensitivity and the maximum saturation signal amount per pixel are degraded. To overcome sensitivity degradation, a microlens is formed on a surface and the light gathering efficiency per pixel is improved, but it is difficult to improve the saturation signal amount as compared with the sensitivity. Thus, the saturation signal amount becomes insufficient relative to the sensitivity and in actual photographing, each pixel easily reaches a saturation region and an image having appropriate gradation cannot be obtained.

To synthesize images different in exposure and enlarge the dynamic range, it is necessary to increase the exposure amount of an overexposure image and decrease the exposure amount of an underexposure image. Particularly, when the exposure amount is increased, the shutter speed becomes low, causing frame rate lowering and subject blurring.

Since each pixel is fine, it is also difficult to divide the pixels into low-sensitivity pixels and high-sensitivity pixels.

### SUMMARY OF THE INVENTION

An object of an illustrative, non-limiting embodiment of the invention is to provide a method and device for driving a solid-state imaging device, an imaging apparatus, and an image synthesizing method, which are capable of taking an image in a wide dynamic range even with a solid-state imaging device with a small saturation output signal amount relative to sensitivity.

According to an aspect of the invention, there is provided a method for driving a solid-state imaging device, the solid-state imaging device including a plurality of pixels arranged in a two-dimensional array, each of the plurality of pixels accumulating a signal charge according to an amount of incident light, the method including: performing electron multiplication of a first signal charge at a first multiplication factor to output a first image signal; and performing electron multiplication of a second signal charge at a second multiplication factor to output a second image signal, at least the first and second image signals being image signals of a same scene of a subject and being successively output.

In the method for driving a solid-state imaging device, at least one of the first and second multiplication factors may be 1.

In the method for driving a solid-state imaging device, the electron multiplication may be performed at a time of reading the signal charge from the pixels.

In the method for driving a solid-state imaging device, the solid-sate imaging device may include a vertical charge transfer path, and the electron multiplication may be performed in the vertical charge transfer path.

In the method for driving a solid-state imaging device, the electron multiplication may be performed by repeating a process under suspension of transferring the signal charge read from the pixels in the vertical charge transfer path, the process including: forming a potential well for electron multiplication below a transfer electrode in the vertical charge transfer path; and dropping the signal charge into the potential well.

In the method for driving a solid-state imaging device, the solid-state imaging device may include a horizontal charge transfer path and an electron multiplication transfer path disposed contiguously to an output stage part of the horizontal charge transfer path, and the electron multiplication may be performed in the electron multiplication transfer path.

In the method for driving a solid-state imaging device, the electron multiplication may be performed each time the signal charge is transferred into the electron multiplication transfer path.

In the method for driving a solid-state imaging device, the electron multiplication transfer path may include at least two branch parts of a first branch part and a second branch part, and the first image signal may be output through the first branch part and the second image signal may be output through the second branch part.

In the method for driving a solid-state imaging device, the first and second signal charges may be accumulated in a same pixel upon one exposure and may be read separately.

In the method for driving a solid-state imaging device, the first and second signal charges may be accumulated in order in a same pixel upon two successive exposures and may be read in order of being accumulated.

According to an aspect of the invention, there is provided a device for driving a solid-state imaging device, including a drive unit that performs the above method driving the solid-state imaging device.

According to an aspect of the invention, there is provided an imaging apparatus including: a solid-state imaging device; and a drive unit that performs the above method for driving the solid-state imaging device.

The imaging apparatus may further include a synthesizing unit that synthesizes the first and second image signals output from the solid-state imaging device.

The imaging apparatus may further include: an operation unit that gives an instruction as to whether it is necessary to enlarge dynamic range of the synthesized image signal of the first and second image signals or an instruction as to a width of the dynamic range; and a multiplication control unit that controls a relationship between the first and second multiplication factor so that the instruction is executed.

In the imaging apparatus, the multiplication control unit may control at least one of a voltage amplitude of an electron multiplication pulse, a pulse width of the electron multiplication pulse, and the number of repetitions of the electron multiplication pulse.

The imaging apparatus may further include a gain adjustment unit that sets a gain made in a later-stage processing in accordance with the first and second electron multiplication factors at a time of reading the first and second image signals from the solid-state imaging device.

According to an aspect of the invention, there is provided a method for synthesizing an image in the above imaging apparatus, including: performing imaging processing of the first and second image signals separately, the first and second image signals being output from the solid-state imaging device; and adding the first and second image signals subjected to the imaging processing to synthesize the image.

In the method for synthesizing an image, the imaging processing may include performing gamma correction for weighting according to a signal level, and the gamma correction is performed so that a correction amount for the first image signal is different from that for the second image signal.

### BRIEF DESCRIPTION OF THE DRAWINGS

The features of the invention will appear more fully upon consideration of the exemplary embodiments of the inventions, which are schematically set forth in the drawings, in which:

FIG. 1 is a block diagram of a digital camera according to a first exemplary embodiment of the invention;

FIG. 2 is a timing chart at the time of imaging processing in the digital camera shown in FIG. 1;

FIG. 3 is a schematic representation for reading a signal charge into a vertical charge transfer path from a photodiode with the first read pulse in FIG. 2;

FIG. 4 is a schematic representation of an electron multiplication operation in the vertical charge transfer path in the first embodiment;

FIG. 5 is a schematic representation of imaging processing of synthesizing unmultiplied image data and multiplied image data in the first embodiment;

FIG. 6 is a schematic representation of an electron multiplication in a second exemplary embodiment of the invention;

FIG. 7 is a timing chart at the time of imaging processing in a third exemplary embodiment of the invention;

FIG. 8 is a block diagram of a digital camera according to a fourth exemplary embodiment of the invention;

FIG. 9 is a drawing to show a modified example of a solid-state imaging device shown in FIG. 8;

FIG. 10 is an enlarged view of an output two-branch portion in FIG. 9; and

FIG. 11 is a schematic representation according to another exemplary embodiment of the output two-branch portion.

### DETAILED DESCRIPTION OF THE EXEMPLARY EMBODIMENTS

Although the invention will be described below with reference to the exemplary embodiment thereof, the following exemplary embodiment and its modification do not restrict the invention.

According to an exemplary embodiment of the invention, since an image signal of a subject with a high electron multiplication factor and an image signal of a subject with a low electron multiplication factor are synthesized, when an overexposure image is taken, the signal amount can be amplified in the imaging device for providing any desired overexposure image without increasing the exposure amount, so that the shutter speed can be increased and frame rate lowering and subject blurring can be suppressed. Since signal amplification is executed in the solid-state imaging device before noise is given, only the signal component is amplified and it is made possible to taking a subject image in a wide dynamic range with good S/N for processing applying a gain at a later stage.

Referring to the accompanying drawing, exemplary embodiments of the invention will be described.

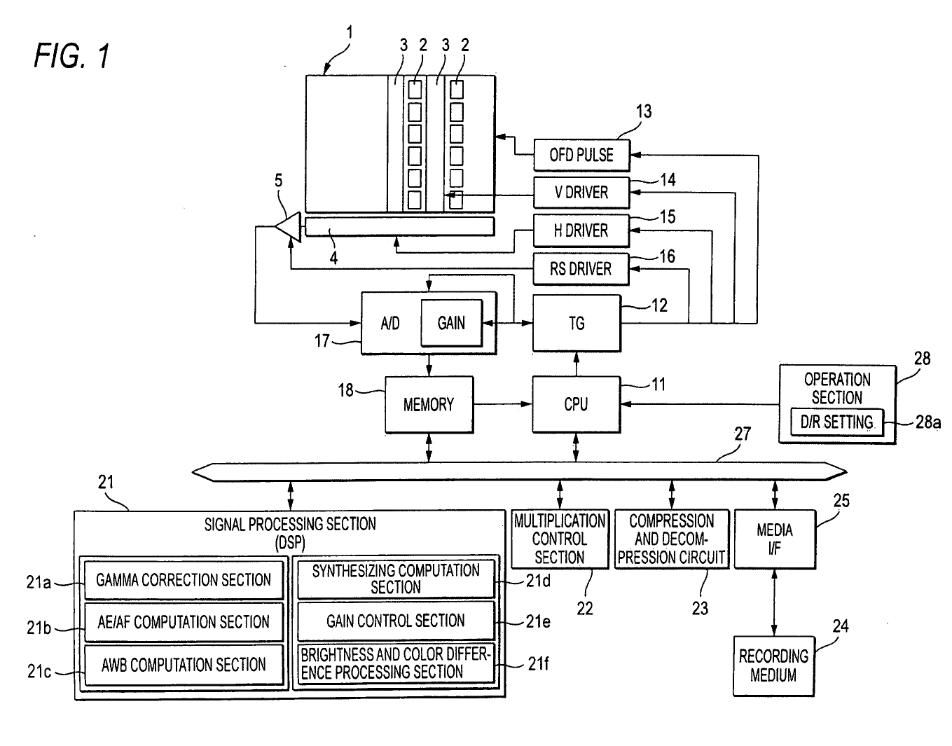

FIG. 1 is a block diagram of a digital camera according to a first exemplary embodiment of the invention. The digital camera includes a solid-state imaging device 1. The solid-state imaging device 1 shown in the figure is an interline transfer CCD solid-state imaging device and includes a plurality of photodiodes (pixels) formed in a two-dimensional array on the surface of a semiconductor substrate, vertical charge transfer paths (VCCDs) 3 formed along photodiode columns, a horizontal charge transfer path (HCCD) 4 formed along ends of the vertical charge transfer paths 3, and an amplifier 5 provided at an output end part of the horizontal charge transfer path 4 for outputting a voltage value signal according to the signal charge amount.

In the description to follow, the interline transfer CCD solid-state imaging device is taken as an example, but the invention can also be applied to any other solid-state imaging device such as a full-frame transfer solid-state imaging device.

The digital camera further includes a central processing unit (CPU) 11 for controlling the whole camera, a timing generator (TG) 12 for generating various drive timing signals according to a command from the CPU 11, various driver circuits 13, 14, 15, and 16 for generating and outputting a drive pulse according to the timing signal from the timing generator 12, an analog front end (AFE) circuit 17 for processing an analog image signal output from the amplifier 5, and main memory 18 for temporarily storing a digital image signal in a manner as described below in detail.

The OFD pulse driver 13 generates an overflow drain (OFD) pulse and applies the pulse to the solid-state imaging device 1, the V (vertical) driver 14 applies a read pulse, a transfer pulse, and an electron multiplication pulse (described below in detail) to the vertical charge transfer path 3, the H (horizontal) driver 15 applies a transfer pulse to the horizontal charge transfer path 4, and an RS (reset) pulse driver 16 applies a reset pulse to an output stage of the horizontal charge transfer path 4.

The AFE circuit 17 performs correlated double sampling processing, gain control (GAIN) processing, and analog-digital conversion (A/D) processing for the analog image signal output from the solid-state imaging device 1 to generate a digital image signal, and temporarily stores the digital image signal in the memory 18.

The digital camera shown in FIG. 1 further includes a signal processing section 21 implemented as a digital signal processor (DSP), an electron multiplication control section 22 described below in detail, a compression and decompression circuit 23 for compressing an image signal to image data in a JPEG format, etc., and decompressing image data, a media interface section 25 for writing and reading the image signal onto and from a recording medium 24, a bus 27 for interconnecting the components, the memory 18, and the CPU 11, and an operation section 28 for the user to enter a command into the CPU 11. The operation section 28 is provided with an RID setting section 28a for the user to enter an instruction (command) of the presence or absence of enlargement of dynamic range of a taken image (i.e., as to whether or not it is necessary to enlarge the dynamic range of the image) or an instruction of a width of the dynamic range.

The signal processing section 21 includes a gamma correction section 21a, an AE/AF computation section 21b, an AWB computation section 21c, a synthesizing computation section 21d, a gain control section 21e, and a brightness and color difference processing section 21f.

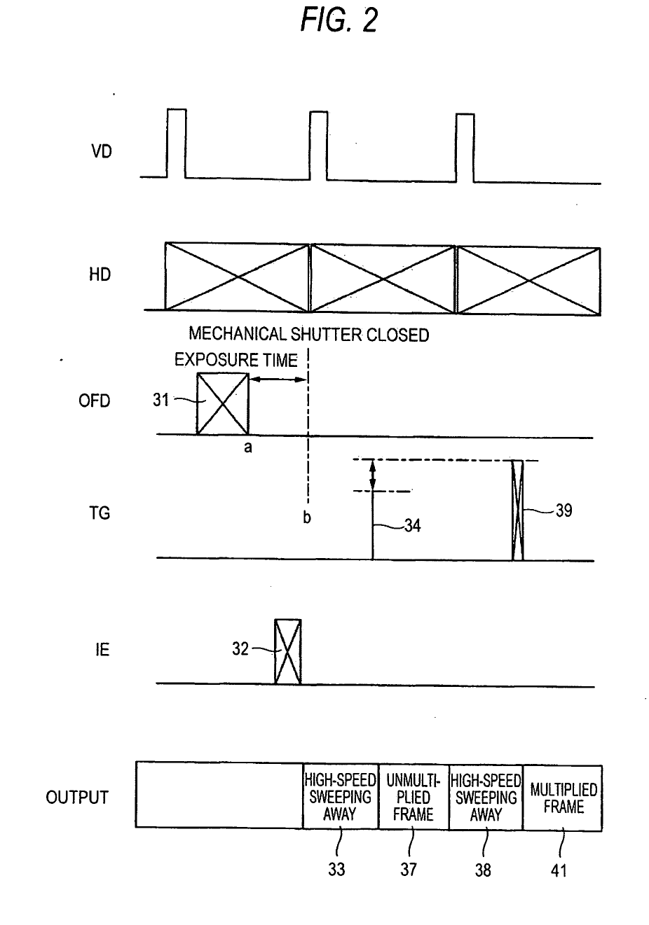

FIG. 2 is a timing chart when a subject image is taken with the digital camera shown in FIG. 1. Imaging processing is performed in accordance with a vertical synchronizing signal VD and a horizontal synchronizing signal HD. The time interval between timing a at which applying of the OFD pulse 31 terminates and timing b at which a mechanical shutter is closed becomes an exposure time period during which each photodiode 2 accumulates signal charges (in many cases, electrons) according to the exposure amount.

If the user enters an instruction of a dynamic range enlargement through the operation section 28 in FIG. 1, the electron multiplication control section 22 outputs an IE control signal 32 indicating the dynamic range enlargement instruction and the later drive control of the solid-state imaging device 1 will be performed based on the instruction.

First, high-speed sweeping away processing 33 of the vertical charge transfer path 3 and the horizontal charge transfer path 4 is performed from the timing b of closing the mechanical shutter and then a read pulse 34 is applied to a read electrode.

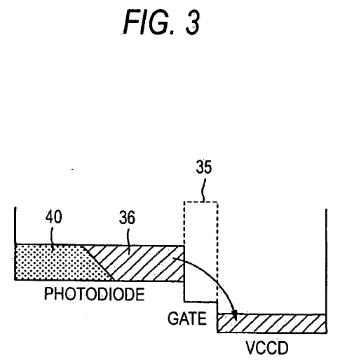

At this time, both or either of the pulse width and the amplitude of the read pulse 34 are controlled and 50% of the accumulated charges in each photodiode 2 is read into the vertical charge transfer path 3. FIG. 3 is a schematic representation for reading signal charges into the vertical charge transfer path 3 from the photodiode 2. Signal charges are accumulated in the photodiode 2 and when the read pulse 34 is applied to a read gate 35, the electric field applied to a part close to the read gate 35 is strong and thus the signal charges flows into the vertical charge transfer path 3 in order stalling at the signal charges closer to the read gate 35.

Thus, the pulse width of the read pulse 34 is controlled and the amplitude is adjusted for performing electric field control, whereby 50% of the accumulated charges in the photodiode 2 can be read into the vertical charge transfer path 3. JP-A-7-322147 discloses a method of reading the accumulated charges in the same photodiode in more than one operation.

The percentage of the amount of the read signal charges need not be 50% and may be a constant percentage in the pixels 2 of the solid-state imaging device 1, such as 30%, 40%, or 50%. However, it is considered that if the same read pulse is applied, large variation in the read percentage in the pixels may occur due to a manufacturing error of the solid-state imaging device 1. In this case, at the inspection time of the solid-state imaging device after manufactured, the solid-state imaging device 1 may be irradiated with light of the same illuminance and the read percentage variation amount when the signal charges are read with the same read pulse may be found and may be retained in memory, etc., as correction data for use for data correction in postprocessing.

Next, output processing 37 of transferring the signal charges read with the read pulse 34 to the vertical charge transfer path 3 and the horizontal charge transfer path 4 is performed and the signals are output from the output amplifier 5 and are converted into digital imaging data in the AFE circuit 17 and then the digital imaging data is retained in the memory 18. For the convenience of the description, this imaging data is referred to as “unmultiplied image data.”

After the unmultiplied image data is output from the solid-state imaging device 1, again high-speed sweeping away processing 38 of the vertical charge transfer path 3 and the horizontal charge transfer path 4 is performed and then an electron multiplication pulse 39 is applied to the vertical charge transfer path 3. Accordingly, signal charges 40 remaining in the photodiode 2 in FIG. 3 are read into the vertical charge transfer path 3.

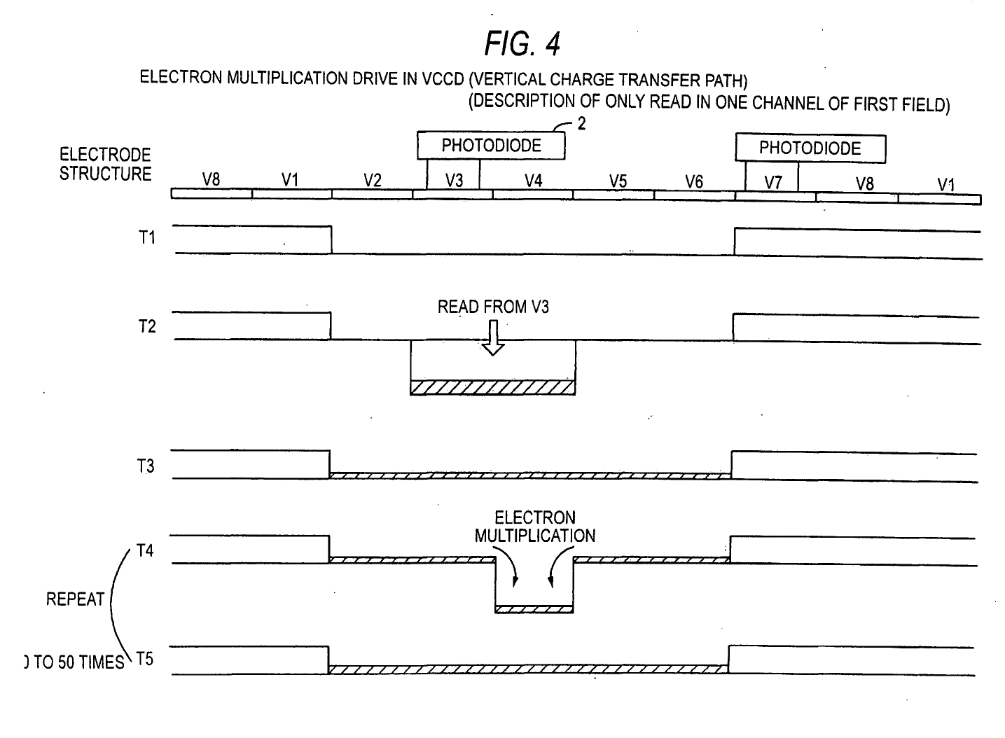

FIG. 4 is a schematic representation of an electron multiplication pulse. In the example shown in FIG. 4, a potential well is formed below transfer electrodes V3 and V4 and when a first pulse of electron multiplication pulse 39 is applied to the electrode V3, residual signal charge 40 of the photodiode 2 flows into the potential well.

In a usual CCD solid-state imaging device, signal charges are read into a vertical charge transfer path and then are transferred in the direction toward a horizontal charge transfer path. In the solid-state imaging device of the embodiment, however, signal charges are not immediately transferred and an electron multiplication of the signal charges is performed in the vertical charge transfer path. In the example shown in FIG. 4, a deep potential well is formed below the electrode V4 at time T4 for signal charges in the state of time T3, namely, retained below electrodes V2, V3, V4, V5, and V6.

For example, if a voltage of about 15 V is applied to the electrode V4 and a deep potential well is formed, signal charge falls into the potential well below the electrode V4 and at this time, an electron multiplication occurs because of the avalanche effect. If the one-time electron multiplication factor is low as about 1% to 2%, an electron multiplication pulse is given repeatedly 10 times to 50 times, whereby a double or triple electron multiplication factor can be obtained in total.

JP-A-2002-290836 discloses performing an electron multiplication on a vertical charge transfer path.

The electron multiplication factor can be controlled by changing the number of the pulses 39 and can also be controlled by changing one electron multiplication factor. The one-time electron multiplication factor can be controlled according to the depth of the potential well formed below the electrode V4 shown at the timing T4 in FIG. 4, namely, the pulse amplitude and can also be controlled according to the pulse width (duration for keeping the state of the timing T4).

After the electron multiplication of the signal charges is performed, output processing 41 of transferring the signal charges in the vertical charge transfer path 3 and the horizontal charge transfer path 4 is performed and the signal charges are output from the output amplifier 5 and are converted into digital imaging data in the AFE circuit 17, and then the digital imaging data is retained in the memory 18 as multiplied image data aside from the unmultiplied image data.

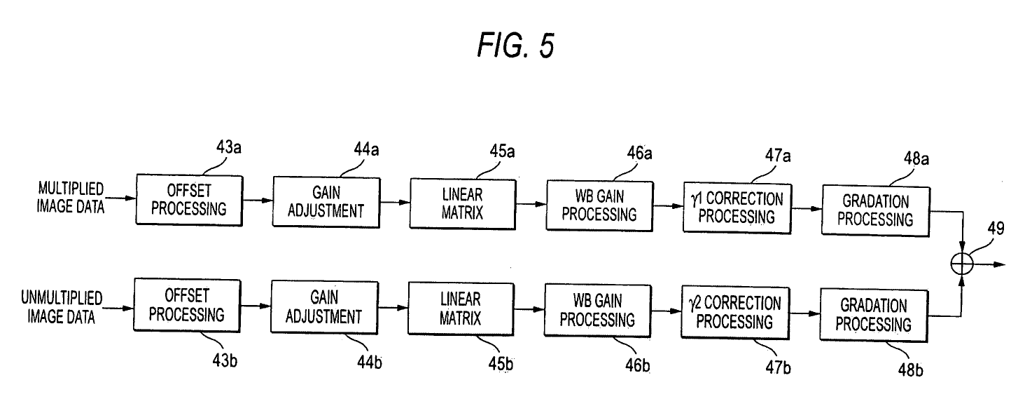

The signal processing section 21 in FIG. 1 performs imaging processing of the unmultiplied image data and the multiplied image data to add and synthesize both the data so as to generate image data with the dynamic range enlarged, as shown in FIG. 5.

In the processing in FIG. 5, offset processing 43a and 43b are performed for the multiplied image data and the unmultiplied image data, then gain adjustments 44a and 44b are performed, then linear matrix processing 45a and 45b are performed, white balance processing 46a and 46b are performed, gamma correction processing 47a and 47b (applying different y values to the multiplied image data and the unmultiplied image data) are performed, then gradation processing 48a and 48b are performed and last both the multiplied image data and the unmultiplied image data are added by an adder 49 to synthesize them.

The compression and decompression circuit 23 generates JPEG image data from the synthesized image and writes the JPEG image data onto the recording medium 24. It is also possible to record the multiplied image data and the unmultiplied image data on the recording medium 24 as RAW data as they are and synthesize the multiplied image data and the unmultiplied image data while correcting by the user with the above-mentioned correction data using synthesizing software in a personal computer, etc.

Since the dynamic range of the synthesized image data depends on the electron multiplication factor of the multiplied image data to be synthesized and the percentage of the first read signal charges, the multiplication control section 22 previously has data of the pulse widths, the amplitudes, the numbers of multiplication repetitions, etc., of the read pulse 34 and the electron multiplication pulse 39 for each photographing condition for each dynamic range enlargement width. If the user specifies the dynamic range enlargement width through R/D setting section 28a, the optimum pulse widths, the optimum amplitudes, the optimum numbers of multiplication repetitions, etc., are controlled automatically.

According to the embodiment described above, it is possible to enlarge the dynamic range of the taken image. In the description given above, first the unmultiplied image data is read and then the multiplied image data is read and they are added and synthesized by way of example, but the read order may be opposite. The data need not be “un”multiplied image data (electron multiplication factor=1) and if one image data and another image data differ in electron multiplication factor, the dynamic range can be enlarged by synthesizing the data. Three pieces of image data different in electron multiplication factor rather than two pieces of image data different in electron multiplication factor may be synthesized. This can similarly apply to other embodiments described later.

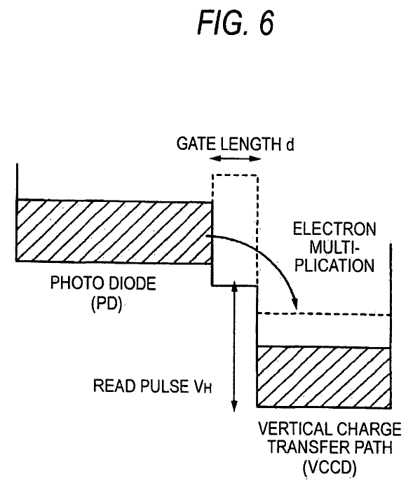

FIG. 6 is a schematic representation of a method for driving a solid-state imaging device according to a second exemplary embodiment of the invention. In the first embodiment, the vertical charge transfer path is driven in electron multiplication so as to multiply one image data to be synthesized. It is also possible to execute an electron multiplication at a time reading signal charges into vertical charge transfer path 3 from photodiode 2, instead of performing an electron multiplication in the vertical charge transfer path. For example, JP-A-5-335549 discloses performing an electron multiplication at a time reading charges from the photodiode.

To read signal charges into the vertical charge transfer path 3 from the photodiode 2, the shorter the gate length and the larger the read pulse amplitude, the steeper is the potential gradient formed between the photodiode 2 and the vertical charge transfer path 3. The electron multiplication factor is proportional to the potential gradient and thus can be controlled by controlling the potential gradient.

Therefore, to apply it to the first embodiment, when initial 50% of signal charges are read, normal read operation is performed and image signals are output from the solid-state imaging device, and when the remaining 50% of the signal charges are read, a high-voltage read pulse is applied for executing an electron multiplication, whereby image data in a wide dynamic range can be provided.

In the case of causing an electron multiplication to occur at a time of reading signal charges from the photodiode, the electron multiplication cannot be repeated several times unlike the first embodiment, and therefore one-time electron multiplication factor needs to be raised. It is also possible to use an electron multiplication together with the electron multiplication in the vertical charge transfer path of the first embodiment.

The embodiment of causing an electron multiplication to occur at a time of reading signal charges from the photodiode can be applied not only to the CCD solid-state imaging device, but also to driving of a CMOS solid-state imaging device. In both the devices, unmultiplied imaging data and multiplied imaging data are synthesized, whereby the dynamic range can be enlarged.

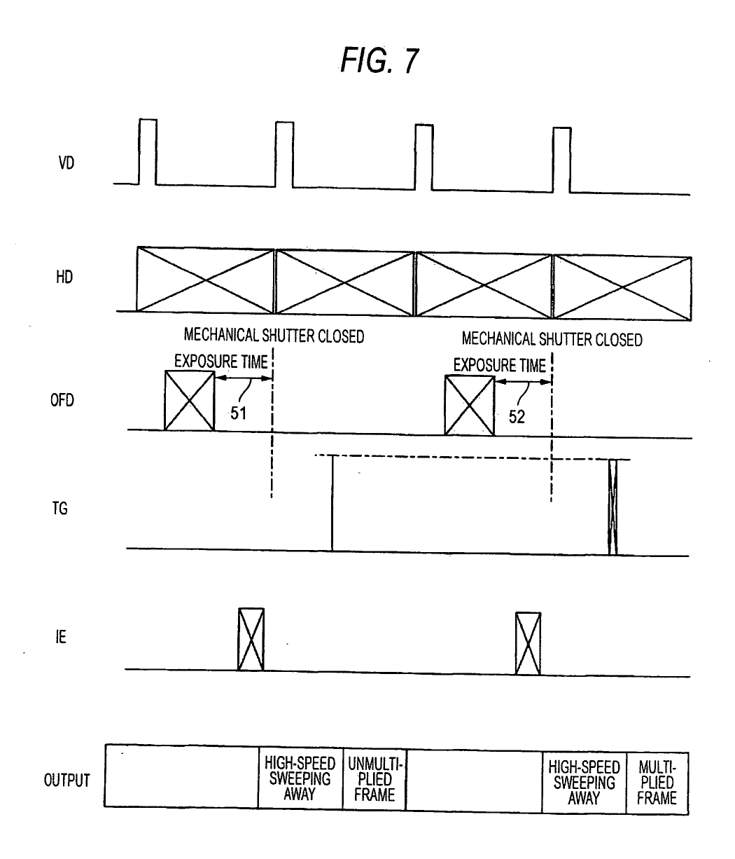

FIG. 7 is a timing chart to show a method for driving a solid-state imaging device according to a third exemplary embodiment of the invention. In the first embodiment, the signal charges accumulated in the photodiode in one exposure processing are divided into two pieces for read, and one is read as unmultiplied image data and the other is read as multiplied image data. Exposure processing of the same subject may be performed twice successively and one may be unmultiplied image data and the other may be multiplied image data.

First, a subject image is taken in a first exposure time period 51 and the imaging data is read as it is and is stored in memory 18 as digital unmultiplied image data. In a second exposure time period 52, the same subject image is taken and an electron multiplication of the imaging data is performed in the vertical charge transfer path in a manner as previously described with reference to FIG. 4, and then the data is stored in the memory 18 as multiplied image data. The unmultiplied image data and the multiplied image data are synthesized by performing the imaging processing in FIG. 5, so that the dynamic range can be enlarged as in the first embodiment.

In the first embodiment, if a moving image is taken, a double image does not result. In the third embodiment, however, when a moving image is taken, it is feared that an image provided by the first exposure and an image provided by the second exposure may shift from each other, resulting in a double image. However, if a still image is taken, the fear of a double image is small. In the third embodiment, it is also possible to change a first photographing condition and a second photographing condition such as a shutter speed.

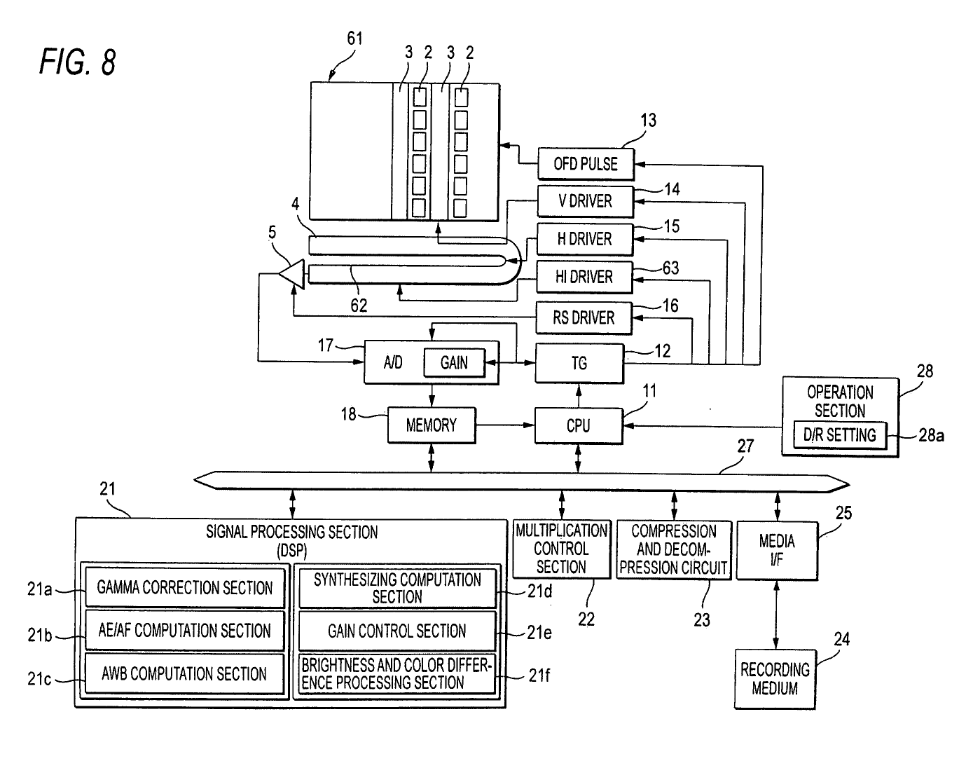

FIG. 8 is a block diagram of a digital camera according to a fourth exemplary embodiment of the invention. The digital camera differs from that of the first embodiment in installed solid-state imaging device. A solid-state imaging device 61 used in the fourth embodiment differs from that of the first embodiment only in that it includes an electron multiplication transfer path 62 at the output stage of a horizontal charge transfer path 4 and thus includes an electron multiplication transfer pulse driver 63. Parts identical with those previously described with reference to the accompanying drawings are denoted by the same reference numerals in FIG. 8 and will not be discussed again. For example, JP-A-2003-347317 discloses including an electron multiplication transfer path at the output end part of a horizontal charge transfer path.

In the fourth embodiment, signal charges transferred from each end part of the vertical charge transfer path 3 to a position off the end part are transferred to an output amplifier 5 while an electron multiplication of the signal charges is performed at each stage in the electron multiplication transfer path 62. Although the electron multiplication factor per stage is small as 1% to 2%, the signal charges are transferred and multiplied at 50 to 100 stages, whereby the electron multiplication factor can be made double or triple. Of course, the electron multiplication factor also changes according to the amplitude of an electron multiplication pulse.

In the embodiment, a plurality of pieces of image data, which is data of an image of the same scene taken and which is different in electron multiplication factor, can be synthesized, thereby providing an image with the dynamic range enlarged.

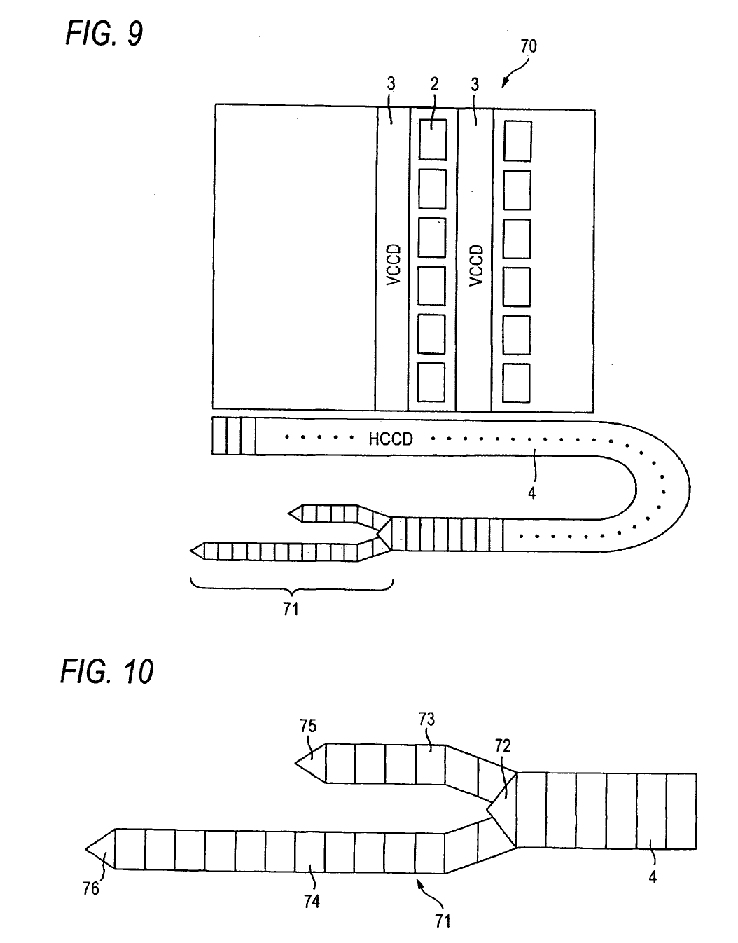

FIG. 9 is a surface schematic drawing of a solid-state imaging device 70 having a two-branch output portion to show a modified example of the solid-state imaging device 61 shown in FIG. 8. An end part of horizontal charge transfer path 4 of the solid-state imaging device 70 is an electron multiplication transfer path 71 having a two-branch output portion.

FIG. 10 is an enlarged view of the two-branch output portion in FIG. 9. The electron multiplication transfer path 71 is branched to multiplication branch transfer paths 73 and 74 provided in parallel through a branch part 72. The number of transfer stages of one multiplication branch transfer path 73 is small and a first amplifier 75 for outputting a voltage value signal according to the signal charge amount is provided at the output end part. The number of transfer stages of the other multiplication branch transfer path 74 is large and a second amplifier 76 for outputting a voltage value signal according to the signal charge amount is provided at the output end part.

In a case of outputting unmultiplied image data, the unmultiplied image data transferred over the horizontal charge transfer path 4 is made to branch to the transfer path 73 at the branch part 72. Since the number of transfer stages of the branch transfer path 73 is small, the electron multiplication factor is small and the branch transfer path 73 is used for output of unmultiplied image data.

In a case of outputting multiplied image data, the unmultiplied image data is made to branch to the transfer path 74 at the branch part 72. Since the number of transfer stages of the branch transfer path 74 is large, the electron multiplication factor is high and the branch transfer path 74 is used for output of multiplied image data.

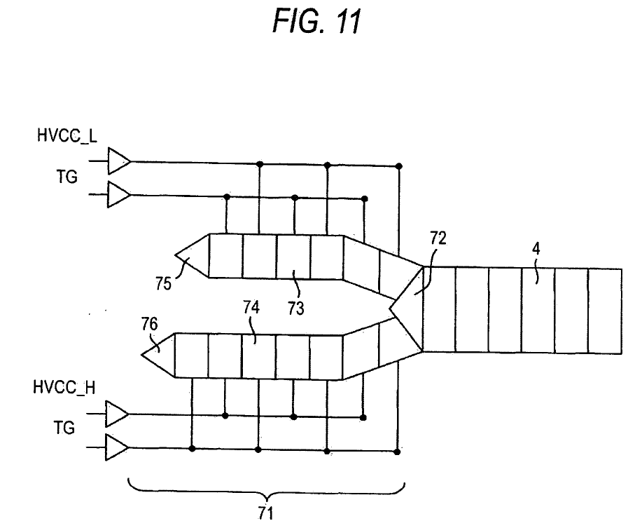

FIG. 11 is an enlarged view of another embodiment of the two-branch output portion. While the electron multiplication factor is controlled according to the number of transfer stages in the embodiment in FIG. 10, the difference between the number of transfer stages of one branch transfer path and that of the other is only one stage in the embodiment in FIG. 11. In the embodiment, the electron multiplication factor is controlled by controlling the transfer pulse amplitude rather than according to the number of transfer stages

That is, signal charges are transferred on branch transfer path 73 with a low-voltage transfer pulse of the same amplitude as horizontal charge transfer path 4, and unmultiplied image data is output from output amplifier 75. On the other hand, signal charges are transferred on branch transfer path 74 with a high-voltage transfer pulse and thus multiplied image data subjected to an electron multiplication is output from output amplifier 76.

According to the embodiments described above, it is also possible to take an image in a wide dynamic range with a solid-state imaging device having minute pixels, and if providing a larger number of pixels for a solid-state imaging device further advances, a solid-state imaging device and an imaging apparatus which are capable of photographing with high sensitivity in a wide dynamic range can be provided.

In the embodiments described above, the imaging apparatus installing the mechanical shutter has been described, but the embodiments can also be applied to the case where the exposure time period is controlled with an electronic shutter without installing a mechanical shutter. In this case, the first exposure time period is from turning off an OFD pulse to the first read pulse and the second exposure time period is from the first read pulse to the next read pulse.

While the first to fourth embodiments and the modified examples have been described, they can also be used in any combination for raising the multiplication factor.

A method for driving the solid-state imaging device according to the embodiments is useful if it is applied to a digital camera installing a solid-state imaging device with a larger number of pixels because it provides the advantage that an image in a wide dynamic range can be taken in a solid-state imaging device having finer pixels.

What is claimed is:

1. A method for driving a solid-state imaging device, the solid-state imaging device including a plurality of pixels arranged in a two-dimensional array, each of the plurality of pixels accumulating a signal charge according to an amount of incident light,
the method comprising:
performing electron multiplication of a first signal charge at a first multiplication factor to output a first image signal; and
performing electron multiplication of a second signal charge at a second multiplication factor to output a second image signal,
at least the first and second image signals being image signals of a same scene of a subject and being successively output.

2. The method according to claim 1, wherein at least one of the first and second multiplication factors is 1.

3. The method according to claim 1, wherein the electron multiplication is performed at a time of reading the signal charge from the pixels.

4. The method according to claim 1, wherein the solid-sate imaging device includes a vertical charge transfer path, and the electron multiplication is performed in the vertical charge transfer path.

5. The method according to claim 4, wherein the electron multiplication is performed by repeating a process under suspension of transferring the signal charge read from the pixels in the vertical charge transfer path, the process including:
forming a potential well for electron multiplication below a transfer electrode in the vertical charge transfer path; and
dropping the signal charge into the potential well.

6. The method according to claim 1, wherein the solid-state imaging device includes a horizontal charge transfer path and an electron multiplication transfer path disposed contiguously to an output stage part of the horizontal charge transfer path, and the electron multiplication is performed in the electron multiplication transfer path.

7. The method according to claim 6, wherein the electron multiplication is performed each time the signal charge is transferred into the electron multiplication transfer path.

8. The method according to claim 6, wherein the electron multiplication transfer path includes at least two branch parts of a first branch part and a second branch part, and the first image signal is output through the first branch part and the second image signal is output through the second branch part.

9. The method according to claim 1, wherein the first and second signal charges are accumulated in a same pixel upon one exposure and are read separately.

10. The method according to claim 1, wherein the first and second signal charges are accumulated in order in a same pixel upon two successive exposures and are read in order of being accumulated.

11. A device for driving a solid-state imaging device, comprising a drive unit that performs a method according to claim 1.

12. An imaging apparatus comprising:
a solid-state imaging device; and
a drive unit that performs a method according to claim 1 to drive the solid-state imaging device.

13. The imaging apparatus according to claim 12, further comprising a synthesizing unit that synthesizes the first and second image signals output from the solid-state imaging device.

14. The imaging apparatus according to claim 13, further comprising:
an operation unit that gives an instruction as to whether it is necessary to enlarge dynamic range of the synthesized image signal of the first and second image signals or an instruction as to a width of the dynamic range; and
a multiplication control unit that controls a relationship between the first and second multiplication factor so that the instruction is executed.

15. The imaging apparatus according to claim 14, wherein the multiplication control unit controls at least one of a voltage amplitude of an electron multiplication pulse, a pulse width of the electron multiplication pulse, and the number of repetitions of the electron multiplication pulse.

16. The imaging apparatus according to claim 15, further comprising a gain adjustment unit that sets a gain made in a later-stage processing in accordance with the first and second electron multiplication factors at a time of reading the first and second image signals from the solid-state imaging device.

17. A method for synthesizing an image in an imaging apparatus according to claim 12, comprising:
performing imaging processing of the first and second image signals separately, the first and second image signals being output from the solid-state imaging device; and
adding the first and second image signals subjected to the imaging processing to synthesize the image.

18. The method according to claim 17, wherein the imaging processing includes performing gamma correction for weighting according to a signal level, and the gamma correction process is performed so that a correction amount for the first image signal is different from that for the second image signal.
